(19) United States
(12) Patent Application Publication
(10) Pub. No.: US 2017/0114630 A1
(43) Pub. Date: Apr. 27, 2017

(54) INTEGRATED MEASUREMENT WHILE DRILLING DIRECTIONAL CONTROLLER

(71) Applicant: MicroPulse, LLC, Houston, TX (US)

(72) Inventors: David ERDOS, Houston, TX (US); Abraham C. ERDOS, Houston, TX (US); Kenneth C. MILLER, Houston, TX (US)

(21) Appl. No.: 14/920,775

(22) Filed: Oct. 22, 2015

(51) Int. Cl. E21B 47/12; E21B 47/024; G01V 11/00; E21B 7/04

(52) U.S. Cl. CPC E21B 47/12; E21B 7/04; E21B 47/024; G01V 11/002

(57) ABSTRACT

An integrated measurement while drilling (MWD) system is an integrated, ruggedized, and condensed MWD system that prevents the failures present in the traditional MWD systems while maintaining a high level of accuracy. The integrated MWD system integrates the processor, power supplies and orientation sensors into a single integrated hardware module. The integration reduces the overall size of an MWD system, reduces the power consumption, increases reliability, and increases the durability of the MWD system.

### TECHNICAL FIELD

The subject matter described herein relates to measurement while drilling (MWD) systems, specifically, MWD systems with integrated sub-systems.

### BACKGROUND

Traditional MWD systems (as shown in FIG. 1) are configured to capture measurements of a wellbore inclination from vertical, and also magnetic heading (i.e., measures the trajectory of the wellbore as it is drilled). The Traditional MWD systems include a variety of disparate components across multiple barrels of a drill string, for example, a transmitter 102; a gamma ray sensor 104; sub-system 110 including: strongback 112 (microprocessor unit (MPU) 116, triple power supply (TPS) 114), orientation module 118; and batteries 106 and 108 (e.g., lithium-ion batteries). The above-mentioned components are generally coupled together by at least four connections (i.e., four connections between each component). The sub-system 110 is approximate 60 inches in length. The orientation module 118 can include three accelerometers (e.g., commercial grade sensors), three magnetometers (e.g., fluxgate sensors), and a temperature sensor. The orientation module 118 and the included sensors require power from the TPS (i.e., +5V, +13V, and −13V).

Traditional MWD systems are susceptible to a high degree of failure. The sensors in the orientation module 118 can be easily damaged (or require frequent recalibration) through vibrations during the drilling process. Traditional MWD system generally cannot be used in air or hammer drilling operations. The at least four connections coupling the components also provides multiple points of failure. Traditional MWD systems also consume a large amount of power and require a TPS and at least two batteries for a practical amount of operational time.

### SUMMARY

Disclosed herein are systems for integrating and ruggedizing traditional MWD systems to prevent failures and condense the size while maintaining accuracy.

In one aspect of the disclosure, the integrated MWD system includes a directional controller including at least one printed circuit board. The printed circuit board includes at least one accelerometer configured to measure inclination and flow of the integrated measurement device and at least one magnetometer configured to measure a direction of the integrated measurement device. The integrated MWD system can include a second directional controller.

In another aspect of the disclosure, the integrated MWD system can include a transmitter, a gamma ray sensor, and a battery coupled to the directional controller. The integrated MWD system can be master processor unit-less, triple power supply-less, and orientation module-less.

In another aspect of the disclosure, the integrated MWD system can include a magnetometer drive circuit configured to cancel an external magnetic field. The magnetometer drive circuit can include a bridge, offset current loop, and a set/reset loop.

In another aspect of the disclosure, the accelerometers of the integrated MWD system includes can be micro electro-mechanical systems (MEMS) accelerometers. The magnetometers can be solid-state magnetometer. The magnetometer can be an anisotropic magnetoresistance (AMR) magnetometer.

In another aspect of the disclosure, the directional controller of an integrated MWD system can be configured to control the telemetry from the integrated MWD system.

In another aspect of the disclosure, the directional controller of an integrated MWD system can be configured as a passive logger for a downhole system. The passive logger can facilitate validation of surveys of other directional sensors downhole.

In another aspect of the disclosure, the directional controller of an integrated MWD system can be configured as a high resolution logger for providing logs indicating system failures.

In another aspect of the disclosure, the transmitter of an integrated MWD system can be is configured to transmit one or more directional readings to a remote surface location. The one or more directional readings can be an inclination. The one or more directional readings can be an azimuth. The one or more directional readings from the accelerometers and magnetometers can be raw measurements from the x-axis, y-axis and z-axis.

In another aspect of the disclosure, the directional controller of the integrated MWD system can be equal to or less than 16 inches in length.

In another aspect of the disclosure, the integrated MWD system is configured in a single barrel. The single barrel can be equal to or less than 10 feet.

### BRIEF DESCRIPTION OF THE DRAWINGS

Preferred embodiments of the subject matter described herein will now be explained with reference to the accompanying drawings, wherein like reference numerals represent like parts, of which:

FIG. 1 illustrates a block diagram of an example traditional MWD system;

FIG. 2 illustrates a block diagram of an example integrated MWD system;

FIG. 3 illustrates a block diagram of an example directional controller of an integrated MWD system;

FIG. 4 illustrates a circuit diagram of an example driving circuit for a magnetometer of an example integrated MWD system; and

FIG. 5 illustrates a flowchart of an example method of an example magnetometer drive circuit.

### DETAILED DESCRIPTION

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

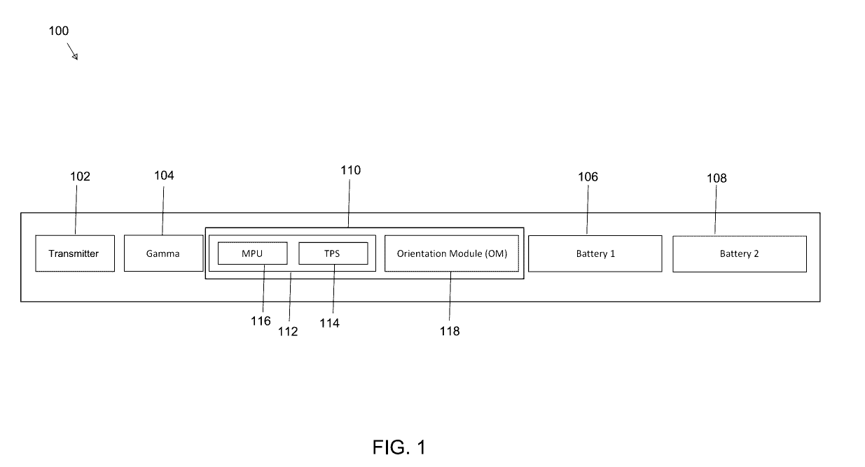

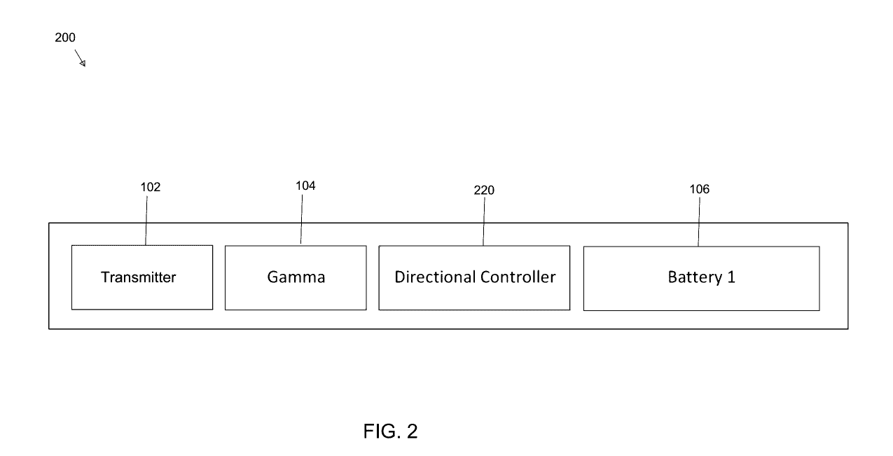

FIG. 2 illustrates an example integrated MWD system 200. Generally, an integrated MWD system 200 is an integrated, ruggedized, and condensed traditional MWD system that prevents the failures present in the traditional MWD systems while maintaining a high level of accuracy. Integrated MWD system 200 can include a transmitter 102 (e.g., pulser, positive mud pulser, negative mud pulser, acoustic transceiver, electromagnetic transceiver, piezo transceiver, etc.), gamma ray sensor 104 (e.g., proportional gamma ray sensor, spectral gamma ray sensor, bulk gamma ray sensor, resistivity sensor, neutron density sensor, etc.), directional controller 220, and at least one battery 106. Directional controller 220 can replace sub-system 110 of a traditional MWD system (as shown in FIG. 1) by integrating the processor, power supplies and orientation sensors into a single integrated hardware module (e.g., integrated onto a single printed circuit board (PCB)). The directional controller 220 reduces the overall size of an MWD system, reduces the power consumption, increases reliability, and increases the durability of the MWD system.

The integrated MWD system 200 can be enclosed in a single barrel of an MWD system string. In some embodiments, the directional controller 220 can be approximately 16 inches in length. In other embodiments, the directional controller 220 can be a range from 12 inches to 24 inches in length. As previously discussed, the traditional MWD sub-system 110 is approximately 60 inches in length. The reduction in length of the directional controller 220 can increase the reliability and ruggedness of the MWD system by utilizing smaller, more rugged hardware components (e.g., micro electro-mechanical systems and solid-state sensors), eliminating connectors/interconnects, and decreasing the overall length, which increases the rigidity and mechanical ruggedness of the MWD system. The reduction in length of the directional controller 220 also enables the entire integrated MWD system 200 to be enclosed in a single barrel. The single barrel can be retrievable from the drill string.

Traditional MWD systems are equipped with large, commercial grade accelerometers (e.g., aerospace inertial grade accelerometers). The commercial grade accelerometers are highly accurate sensors (e.g., to +/−0.1 degrees). However, commercial grade accelerometers are highly susceptible to failure. Commercial grade accelerometers also require constant recalibration during use downhole. Furthermore, commercial grade accelerometers require a significant amount of power (e.g., TPS, +13V and -13V power source, etc.).

Traditional MWD systems are generally equipped with fluxgate magnetometers. Fluxgate magnetometers are known for their high sensitivity. However, fluxgate magnetometers require a fairly complex driving circuit. Furthermore, fluxgate magnetometers are generally large in size (approximately 1″×1″×0.25″). Traditional MWD require at least two fluxgate magnetometers for proper operation.

In some embodiments, the integrated MWD system 200 can be configured to use micro electro-mechanical systems (MEMS) accelerometers and solid-state magnetometers. The MEMS accelerometers and solid-state magnetometers require less power and fewer voltage rails than the commercial grade sensors, (i.e., TPS 114 is not required in the integrated MWD system 200). The MEMS accelerometers and solid-state magnetometers can provide a more compact MWD system that is more reliable, durable, and consumes less power while still providing the same level of accuracy, as described below.

In some embodiments, the integrated MWD system 200 can include one or more directional controllers 220 to prevent magnetic interference. Generally, an MWD system is enclosed in a non-magnetic collar to prevent magnetic interference from the large amount of steel near the drill bit. However, the bottom of the MWD (i.e., closest to the drill bit) is near the end of the non-magnetic collar, thus, magnetic readings taken closer to the end of the non-magnetic collar can experience magnetic interference. However, obtaining inclination measurements as close to the drill bit as possible is important for accurate positioning of the well. Positioning a second directional controller (i.e., for magnetometer measurements) further from the drill bit and inside the non-magnetic collar can prevent interference with the magnetic measurements. For example, a first directional controller can be positioned closer to the drill bit (e.g., further down hole at the end of a non-magnetic collar) and a second directional controller can be positioned further way from the drill bit (e.g., further up hole within the non-magnetic collar). The first directional controller can measure and transmit inclination values (i.e., calibrated accelerometer values) to the second directional controller. The second directional controller can calculate azimuth values by magnetometer measurements (taken at the second directional controller) and by the received accelerometer measurements from the first directional controller. Thus, reducing any potential magnetic interference with the magnetic measurements.

In other embodiments, there can be magnetic interference from the steel drill pipe at the upper end of the non-magnetic collar and from the mud motor at the lower end of the non-magnetic collar. Magnetic field measurements can be measured at two or more points within the non-magnetic collar (e.g., a first directional controller can measure the magnetic field at a first point within the non-magnetic collar and a second directional controller can measure the magnetic field at a second point within the non-magnetic collar). The measurements at the two or more points can be used to calculate a magnetic gradient. The magnetic gradient can be used to subtract out the magnetic interference above and below the non-magnetic collar. Subtracting out the magnetic interference can enable the use of a shorter non-magnetic collar, while still obtaining accurate magnetic readings (i.e., azimuth). A shorter non-magnetic collar can save in the costs of production and operation, and simplify operations of the MWD system.

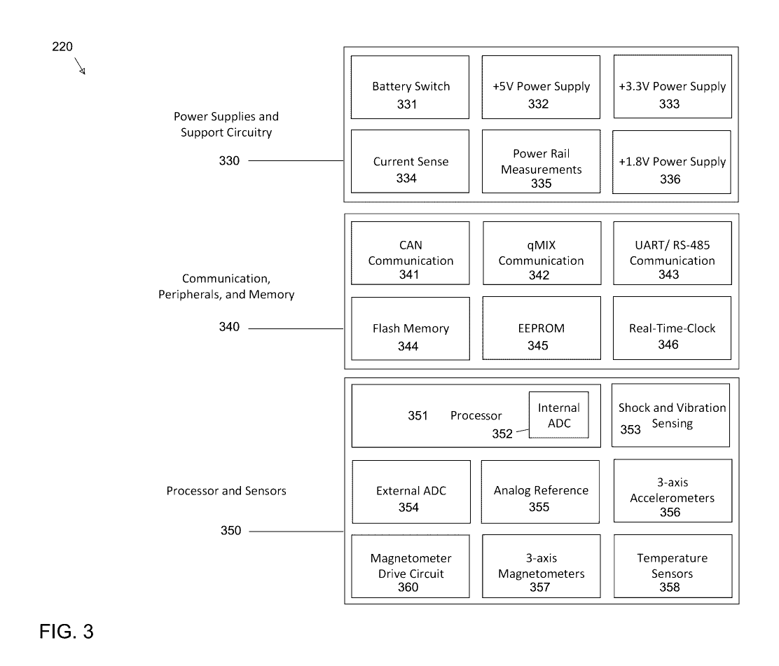

FIG. 3 illustrates an example directional controller 220. Directional controller 220 can include three sub-systems: power supplies and support circuitry sub-system 330; communication, peripherals, and memory sub-system 340; and processor and sensors sub-system 350. Directional controller 220 can be integrated onto a single PCB. Integrating the sub-systems of the directional controller 220 on a single PCB can avoid unnecessary wired connections (present in the traditional MWD system 100) providing a more reliable and durable MWD system. For example, the integrated MWD system 200 can withstand more vibration (i.e., can be used in hammer drill and air drill operations). In other embodiments, directional controller 220 can be integrated onto one or more PCBs.

Power supplies and support circuitry sub-system 330 can include a battery switch 331, +5V power supply 332, +3.3V power supply 333, +1.8 power supply 336, current sense 334, and power rail measurements 335.

Battery switch 331 can be configured to facilitate sequential depletion of the power sources. For example, battery switch 331 can be configured to switch from a first battery to a second battery, when the first battery is fully depleted. Sequential depletion of the power sources enables the integrated MWD system 200 to operate more efficiently. For example, when the integrated MWD system 200 is used during a drill run, the first battery is used until completely depleted and then, after the first battery is completed depleted the second battery can be used. When a drill run finishes before the first battery is completely depleted and the second battery is fully charged. Thus, the second battery can be used in future drill operations. Alternatively, in an embodiment where both the first and second battery were depleted (at least at some level), both would not be used in future drilling operations resulting in inefficient and more costly drill operations.

The power supplies 332, 333 and 336 are configured to supply power to all of the electronics of the directional controller 220. The different components of the directional controller 220 can require different voltages. Power supplies 333 and 336 can supply power to processor 351. Power supply 333 can supply power to accelerometers 356. Power supply 332 can supply power to the input/output communication modules 341, 342, and 343, shock and vibration sensors 353, the magnetometer drive circuit 360, 3-axis magnetometers 357, the external ADC 354, and temperature sensors 358.

Current sense 334 and power rail measurements 335 can be used for diagnostics purposes. For example, current sense 334 and power rail measures 335 can read the output voltage of the power supplies 332, 333, and 336 and current consumption of the directional controller 220, which can be used for health monitoring and preventative maintenance of the MWD system 200.

In some embodiments, power for operating the integrated MWD system 200 can be generated at sub-system 330 by vibrations captured during drilling operations (e.g., using a vibration generator that converts the vibrations of the drill string into useable power).

Communications, peripherals, and memory sub-system 340 can include a controller area network (CAN) communication 341, qMIX communication 324, UART/RS-485/RS-232 communication 343, a flash memory 334, EEPROM 345, and real-time clock 346.

Controller area network (CAN) communication 341, qMIX communication 324, and UART/RS-485/RS-232 communication 343 are all alternative forms of system communication for integrated MWD system 200. For example, the output of the sensors (e.g., directional readings) can be transmitted from the sensors to the other components of the integrated MWD system 200 by the above-mentioned protocols.

Flash memory 344 and EEPROM 345 can be used to store operational logs of downhole measurements, parameters and configurations. Real-time clock 346 can be configured to provide time-stamps for all measurements, parameters, and configurations recorded. In some embodiments, the measurements, parameters, and configurations can be used to identify system failures (e.g., if the gamma counts spike when shock events or high vibration occurs, that can indicate the gamma is failing, or if the battery voltage drops under heavy vibration, that can indicate a battery failure).

In other embodiments, directional controller 220 can capture directional measurements, which can be stored in flash memory 334 and/or EEPROM 345. In other embodiments, directional controller 220 can measure and log detailed diagnostic information (e.g., system voltages, vibration levels, shock events, gamma radiation levels, etc.) used for troubleshooting system failures. In other embodiments, directional controller 220 can be used as a passive logger (e.g., facilitate validation of the surveys recorded by another directional sensor or MWD system). In other embodiments, directional controller 220 can be used as a high-resolution logger (e.g., capturing and providing logs for use in analyzing and troubleshooting system failures). In other embodiments, directional controller 220 can provide directional readings (e.g., inclination, azimuth, or raw measurements) to other components in the MWD system by serial communication protocol over a serial communication layer (as illustrated in above).

Processor and Sensors sub-system 350 includes at least one processor 351. Processor 351 can include an internal analog-to-digital (ADC) converter 352. The ADC 352 can measure the integrated MWD system 200 voltages (e.g., battery 1 106), the voltage rails (i.e., +5V power supply 332, +3.3V power supply 333, +1.8V power supply 336, etc.), the current sense 334, the shock and vibration accelerometer 353, the temperature sensor 358, and the magnetometer drive circuit 360.

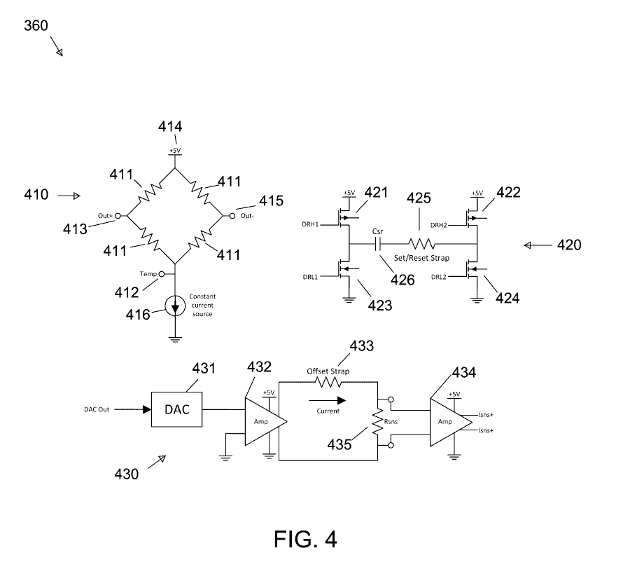

Sub-system 350 can also include, an external ADC 354, analog reference 355, magnetometer drive circuit 360 (illustrated in FIG. 4), one or more 3-axis magnetometers 357, one or more shock and vibration sensors 353, one or more 3-axis accelerometers 356, and one or more temperature sensors 358 (e.g., resistance temperature detector, thermocouple, thermistor, silicon band gap temperature sensor, etc.).

Shock and vibration sensor 353 (e.g., one or more accelerometers) can be in-plane of PCB (and/or perpendicular to the PCB) for providing real-time data to a drill operator. In some embodiments, shock and vibration sensor 353 can provide real-time drilling parameters (e.g., revolutions per minute, stick slip, bit bounce, vibration spectrum, etc.). Shock and vibration sensor 353 can also measure shock and vibration levels stored in failure analysis logs in flash memory 334 and/or EEPROM 345 for future review (e.g., download logs and review at a later time).

The external ADC 354 can be a high resolution ADC used to derive measurements from the magnetometers 357. In other embodiments, the external ADC 354 can derive measurements of the bridge voltage output and the offset strap current (as illustrated in FIG. 4). Analog reference 355 can provide a reference voltage to external ADC 354 (and internal ADC 352). The analog reference 355 can be a fixed value irrespective of any external conditions (e.g., the load on a device, power supply variations, temperature changes, passage of time, etc.). The analog measurements recorded by external ADC 354 (and internal ADC 352) can be referenced to the analog reference 355 to detect fluctuations in voltage.

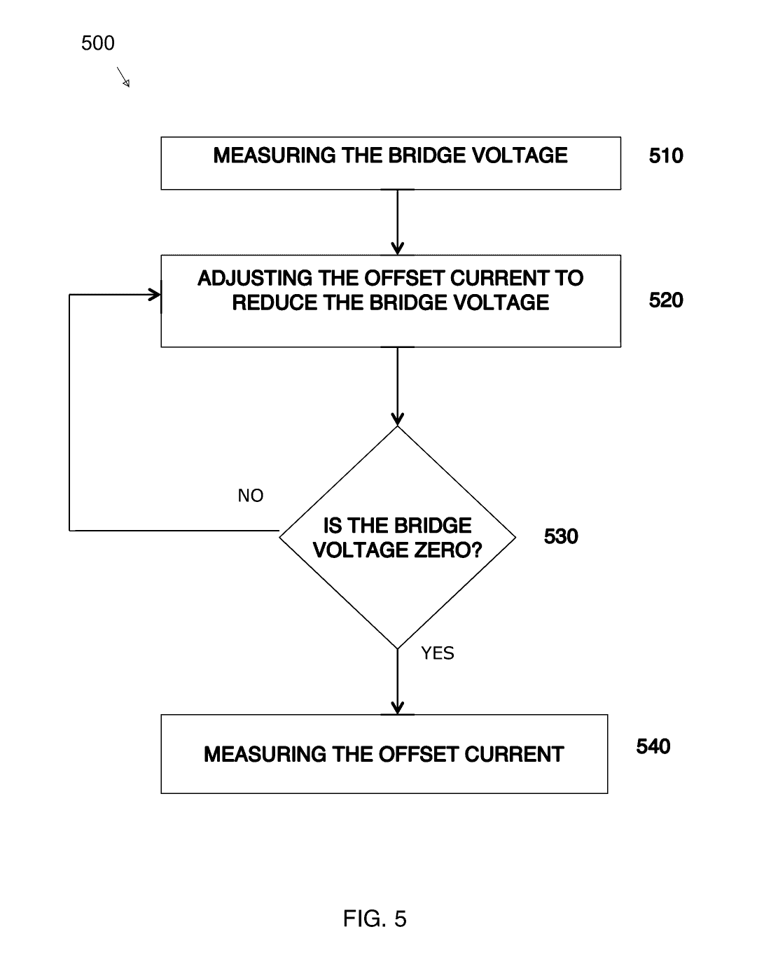

Temperature sensors 358 can monitor the temperature of integrated MWD system 200. In other embodiments, the temperature sensors 358 can perform temperature compensation of the magnetometer 357 outputs. However, the magnetometer 357 outputs can be temperature compensated based off of a voltage measurement taken directly from the magnetometers 357, which can change linearly with temperature (as shown in FIG. 4 and FIG. 5).

The one or more 3-axis accelerometers 356 can be used to measure inclination and flow. For example, accelerometers 356 can be MEMS accelerometers, quartz flex servo accelerometers, etc. In one embodiment, directional controller 220 can include 11-axis of accelerometers (i.e., two 3-axis accelerometers for measuring inclination, two shock and vibration accelerometers 353, and one 3-axis accelerometers for measuring flow). In other embodiments, there can be two or more shock and vibration accelerometers. In other embodiments, there can be two or more 3-axis accelerometers for measuring inclination. In other embodiments, there can be one or more 3-axis accelerometers for measuring flow.

In some embodiments, transmitter 102 can telemeter inclination measurements (e.g., measured by 3-axis accelerometers 356 and calculated by directional controller 220) to the surface. In other embodiments, transmitter 102 can telemeter raw data to the surface. For example, a 3-axis accelerometer can measure readings on the x-axis, y-axis, and z-axis. The raw readings of these axes can be telemetered (i.e., individually) to the surface where the inclination or any corrections can be processed. In some embodiments data transmitted by transmitter 102 can be encoded and formatted by directional controller 220.

In some embodiments, non-commercial accelerometers 356 (e.g., MEMS accelerometers) can be less sensitive than commercial grade accelerometers (in orientation module 118) and can have potential non-linearities in the readings at certain orientations. In order to compensate for the sensitivity and potential non-linearities, the non-commercial accelerometers 356 can be orientated at different angles on the PCB to enable the non-commercial accelerometers 356 to obtain accurate readings at all orientations of the integrated MWD system 200. For example, a first accelerometer can be oriented at 0 degrees and a second accelerometer can be oriented at 45 degrees relative to first (or other) accelerometers. The offset orientation enables the accelerometers to obtain highly accurate readings (i.e., equivalent to the commercial grade accelerometers) regardless of the orientation of the integrated MWD system 200. For example, when the MWD system is substantially vertical, substantially horizontal, at 45 degrees, etc. The accuracy is achieved by always having one accelerometer at a substantially optimal reading orientation (e.g., during directional drillings). Thus, the orientation of the non-commercial accelerometers 356 enables a substantially similar level of accuracy (+/−0.1 degree) as the commercial grade accelerometers.

In some embodiments, the accelerometers can detect flow. For example, a 3-axis accelerometer can detect vibrations of mud flow around the integrated MWD system 200. The detection of flow can determine the operational status of the drill string. For example, when the accelerometer detects flow the drill is operational and when the accelerometer does not detect flow the drill is currently not operational. In some embodiments, when flow is detected, the transmitter 102 can commence transmitting to enable communication between the downhole tools and the driller operator.

The magnetometer drive circuit 360 and one or more magnetometers 357 can be used to determine the direction of the magnetic vector. Accurate magnetic readings are required to determine the direction and location of a well. The magnetometer drive circuit 360 (as illustrated in FIG. 4) can be an electrical circuit configured to measure the magnetometer output, and also to control the magnetometers in a closed loop configuration (e.g., to control the current in the offset strap to drive the bridge output to zero). In some embodiments, the magnetometer can be solid-state magnetometers, anisotropic magnetoresistance (AMR) magnetometers, fluxgate magnetometers, giant magnetoresistance magnetometers, tunneling magnetoresistance elements, gain magneto resistance elements, etc.

In some embodiments, transmitter 102 can telemeter the direction of the magnetic vector (e.g., measured by magnetometers 357 and calculated by directional controller 220) to the surface. In other embodiments, transmitter 102 can telemeter raw data to the surface. For example, a 3-axis magnetometer 357 can measure readings on the x-axis, y-axis, and z-axis. The raw readings of these axes can be telemetered (i.e., individually) to the surface where the direction of the magnetic vector or any corrections can be processed. In some embodiments data transmitted by transmitter 102 can be encoded and formatted by directional controller 220.

The inclination of the accelerometers and the direction of the magnetic vector of the magnetometers can be used to calculate a compass heading (i.e., azimuth). The compass heading can be used to determine the direction of the MWD system. The direction can be used to determine the orientation of the drill string for use in directional drilling.

FIG. 4 illustrates a circuit diagram of an example magnetometer drive circuit 360 with one or more magnetometers. Magnetometer drive circuit 360 can include three sub-circuits: bridge 410, set/reset strap 420, and offset current strap 430. In some embodiments, the magnetometers cannot operate properly (i.e., obtain reliable readings) at high temperatures (e.g., approximately 350 F). For example, in a high temperature environment the output of the magnetometer can become unreliable (i.e., non-linear). When the output of the magnetometer is unreliable, the orientations calculated will not be accurate enough for drilling operations. In some embodiments, the magnetometer drive circuit 360 can be configured to enable the magnetometers to operate at high temperatures by using closed loop magnetic field sensing, constant-current drive of the magnetometer bridge, oversampling of sensors, utilization of a set/reset straps, and taking temperature measurement directly from the bridge.

The bridge 410 (e.g., Wheatstone bridge, resistor bridge, measurement bridge, etc.) can be configured to measure an unknown electrical resistance change (e.g., measured at out+ 413 and out− 415), created by the applied magnetic field. The bridge 410 can include a plurality of resistors 411. In some embodiments, magnetometers 357 can include resistors 411. For example, the magnetometers 357 (e.g., AMR magnetometers) can include elements (e.g., resistors 411) assembled in the bridge 410. In this configuration, the resistance of the elements change when an external magnetic field is applied. The bridge 410 can also include out+ 413, out− 415, and temperature output 412, which can input to processor 351 (to internal ADC 352). The bridge 410 can also include a +5V input 414.

In some embodiments, as the temperature of the integrated MWD system 200 increases, the resistance of the bridge increases (along with the voltage across the bridge). While a constant voltage can be commonly applied to the bridge to obtain a voltage output, maintaining a constant current through the bridge can further reduce the temperature dependence of the voltage output. For example, by placing a constant current source 416 on the low side of the bridge.

The set/reset strap 420 can be configured to negate hysteresis and offset errors of the magnetometers 357. In some embodiments, the set/reset strap 420 can surround the bridge resistors 411. In some embodiments, magnetometers 357 can include resistor 425. For example, the magnetometers 357 (e.g., AMR magnetometers) can include elements (e.g., resistor 425) assembled in the set/reset strap 420. In some embodiments, set/reset strap 420 can include P-channel field-effect transistors 421 and 422 and N-channel field-effect transistors 423 and 424 (e.g., running in depletion-mode). The field-effect transistors 421-424 can receive (i.e., as input at the gate) output from processor 351. In some embodiments, set/reset strap 420 can also include capacitor 426.

In some embodiments, to eliminate or negate hysteresis and offset errors, a large current pulse can be provided through the set/reset strap 420 (driven by the magnetometer driver circuit 360) causing the direction of sensitivity to be toggled and reset. In some embodiments, the set/reset strap 420 can be operated by sending positive and negative current pulses through resistor 425; with a positive current pulse across 425, the bridge 410 becomes sensitive to a magnetic field in one direction and with a negative going current pulse the bridge 410 becomes sensitive to a magnetic field in the opposite direction. Magnetometer 357 readings from the bridge 410 (i.e., at out+ 413 and out− 415) can be taken after both set and reset pulses. The corrected bridge measurement is then taken as the difference between the measurement taken after the positive going current pulse and the measurement taken after the negative going current pulse. The offset and gain errors of the magnetometers 357 can be removed and hysteresis can be eliminated by frequently (e.g., multiple times a second, 125 Hz, etc.) providing a set and reset pulse to the bridge 410.

In other embodiments, set and reset pulses can be sent to the set/reset strap 420. A small amount of zero-mean Gaussian noise can be added to the measurement, since the magnetometer 357 do not reset to the same sensitivity in every instance. The measurement can then be oversampled and averaged, increasing the overall measurement resolution and signal to noise ratio.

In some embodiments, the offset current strap 430 can surround the bridge resistors 411, enabling current to be driven through the offset current strap 430, which can cancel out any external magnetic field. In some embodiments, magnetometers 357 can include resistor 433. For example, the magnetometers 357 (e.g., AMR magnetometers) can include elements (e.g., resistor 433) assembled in the offset current strap 430. In some embodiments, offset current strap control 430 can include a digital-to-analog converter (DAC) 431 configured to receive an output from processor 351. The DAC 431 can be serially connected to amplifier 432. The amplifier 432 can then connected to resistor 433 to form offset current strap control 430. The offset current strap 430 can also include resistor 435 connected in parallel to amplifier 434, which outputs a voltage proportional to the current passing through 435 to the external ADC 354 which is connected to the processor 351.

In some embodiments, to enable operation of the magnetometers 357 in closed loop mode, a voltage measurement of the bridge 410 can be determined. When the voltage measure is not zero, the current of the offset current strap 430 can be controlled to drive the bridge 410 voltage to zero (i.e., by the magnetometer drive circuit 360). A measurement of the magnetic field is directly proportional to the current required to nullify the voltage measurement. The offset current can then be measured directly and configured as the magnetic field reading. Driving the voltage of the bridge 410 to zero (i.e., controlling the magnetometers 357) can reduce the magnetometer 357 temperature dependent gain error.

In some embodiments, the temperature dependence of the bridge 410 resistance is linear. The voltage across the bridge 410 (e.g., the difference between the voltage reading at temp 412 and +5V 414) can be used as a temperature measurement of the magnetometer 357. The temperature measurement can be used to perform a temperature compensation of the magnetometer readings. The compensation can provide that the temperature reading has no lag or offset and is proportional to the magnetometer temperature. This process can enable very accurate temperature compensation of the magnetometer readings.

The method illustrated in FIG. 5 is provided by way of example as there are a variety of ways to carry out the method. Additionally, while the example method is illustrated with a particular order of steps, those of ordinary skill in the art will appreciate that FIG. 5 and the steps illustrated therein can be executed in any order that accomplishes the technical advantages of the present disclosure and can include fewer or more steps than illustrated.

Each step shown in FIG. 5 represents one or more processes, methods or subroutines, carried out in example method. The steps illustrated in FIG. 5 can be implemented in a system illustrated in FIG. 3 and FIG. 4.

FIG. 5 illustrates a flowchart of an example method 500 for magnetometer drive circuit 360. Method 500 can begin at step 510. At step 510 the voltage of bridge 410 can be measured (e.g., the voltage difference between out+ 413 and out− 415). In some embodiments, when the voltage measured is zero the method 500 can end. In some embodiments, when the voltage measured is greater (or less) than zero an external magnetic field can be present. The external magnetic field can affect the operation of the magnetometers. When the voltage is greater (or less) than zero, the method 500 can proceed to step 520.

At step 520, the offset current can be adjusted to reduce the measured voltage of bridge 410, this is attained through cancellation of the external magnetic field by applying a local magnetic field with the opposite direction. For example, offset current strap 430 can be adjusted (e.g., processor 351 can control DAC 431 to output specific voltages to adjust the current through resister 433) to create a magnetic field with the same magnitude but opposite direction, relative to the externally applied field (e.g. earth's magnetic field), around the bridge 411, resulting in the output voltage of bridge 410 being zero. When the offset current has been adjusted the method 500 can proceed to step 530.

At step 530, method 500 can measure the voltage of bridge 410. When the voltage of bridge 410 is greater than or less than zero, method 500 can return to step 520. When the voltage of bridge 410 is approximately zero, the method 500 can proceed to step 540.

At step 540, method 500 can measure (e.g., the voltage measured across resister 435, amplified by amplifier 434 and transmitted to external ADC 354) the offset current at offset current strap 430. In some embodiments, the offset current can correspond proportionally to the externally applied magnetic field. When the offset current is measured the method 500 can end.

Following long-standing patent law convention, the terms “a” and “an” mean “one or more” when used in this application, including the claims.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are present, but other elements can be added and still form a construct or method within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

The word “coupled” is defined as connected, whether directly or indirectly through intervening components, and is not necessarily limited to physical connections. The term “communicatively coupled” is defined as connected whether directly or indirectly though intervening components, is not necessarily limited to a physical connection, and allows for the transfer of data.

Based on the disclosure and teachings provided herein, a person of ordinary skill in the art will appreciate other ways and/or methods to implement the various embodiments. The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A integrated measurement while drilling system comprising:
a directional controller including at least one printed circuit board, the printed circuit board including:
at least one accelerometer configured to measure inclination and flow of the integrated measurement device; and
at least one magnetometer configured to measure a direction of the integrated measurement device.

2. The integrated measurement while drilling system of claim 1, further comprising a transmitter, a gamma ray sensor, and a battery coupled to the directional controller.

3. The integrated measurement while drilling system of claim 1, which is master processor unit-less, triple power supply-less, and orientation module-less.

4. The integrated measurement while drilling system of claim 1, further comprising a magnetometer drive circuit configured to cancel an external magnetic field.

5. The integrated measurement while drilling system of claim 4, wherein the magnetometer drive circuit includes a bridge, offset current loop, and a set/reset loop.

6. The integrated measurement while drilling system of claim 1, wherein the accelerometer is a micro electro-mechanical systems (MEMS) accelerometer.

7. The integrated measurement while drilling system of claim 1, wherein the magnetometer is a solid-state magnetometer.

8. The integrated measurement while drilling system of claim 1, wherein the magnetometer is an anisotropic magnetoresistance (AMR) magnetometer.

9. The integrated measurement while drilling system of claim 1, wherein the directional controller is configured to control the telemetry from the integrated measurement while drilling system.

10. The integrated measurement while drilling system of claim 1, wherein the directional controller is configured as a passive logger for a downhole system.

11. The integrated measurement while drilling system of claim 10, wherein the passive logger facilitates validation of surveys of other directional sensors downhole.

12. The integrated measurement while drilling system of claim 1, directional controller is configured as a high resolution logger for providing logs indicating system failures.

13. The integrated measurement while drilling system of claim 1, wherein the transmitter is configured to transmit one or more directional readings to a remote surface location.

14. The integrated measurement while drilling system of claim 13, wherein the one or more directional readings is an inclination.

15. The integrated measurement while drilling system of claim 13, wherein the one or more directional readings an azimuth.

16. The integrated measurement while drilling system of claim 13, wherein the one or more directional readings from the accelerometers and magnetometers are raw measurements from the x-axis, y-axis and z-axis.

17. The integrated measurement while drilling system of claim 1, wherein the directional controller is less than 16 inches in length.

18. The integrated measurement while drilling system of claim 1, wherein the integrated measurement while drilling system is configured in a single barrel.

19. The integrated measurement while drilling system of claim 18, wherein the single barrel is less than 10 feet.

20. The integrated measurement while drilling system of claim 1 further comprising a second directional controller.
